(19) United States
(12) Patent Application Publication
(10) Pub. No.: US 2024/0166122 A1
(43) Pub. Date: May 23, 2024

(54) VEHICLE LIGHT FIXTURE SYSTEM AND METHOD FOR CONTROLLING VEHICLE LIGHT FIXTURE UNIT

(71) Applicant: Stanley Electric Co., Ltd., Tokyo (JP)

(72) Inventors: Ryotaro OWADA, Meguro-ku, Tokyo (JP); Akihiro NAKATANI, Meguro-ku, Tokyo (JP)

(73) Assignee: Stanley Electric Co., Ltd., Tokyo (JP)

(21) Appl. No.: 18/282,996

(22) PCT Filed: Apr. 21, 2022
(86) PCT No.: PCT/JP2022/018476

§ 371 Date: Sep. 20, 2023

(30) Foreign Application Priority Data
Apr. 23, 2021 (JP) 2021-073435

(51) Int. Cl. B60Q 1/08; B60Q 1/14; H04N 23/57

(52) U.S. Cl. CPC B60Q 1/08; B60Q 1/14; H04N 23/57

(57) ABSTRACT

The present disclosure provides a vehicle light fixture system capable of controlling an optical axis of a vehicle light fixture, without preparing a dedicated light source. A vehicle light fixture system including: circuitry configured to detect a position of a masking target object present in front of a vehicle; set, based on the position of the masking target object, a non-illumination area in which the masking target object is not illuminated; control the vehicle light fixture unit to illuminate an illumination area other than the non-illumination area; store in advance a position of a reference spot pattern that is formed, on a screen disposed ahead of the vehicle, by light emitted from the vehicle light fixture unit installed on the vehicle, in a state in which an optical axis is aligned with a designed optical axis; calculate a misalignment amount; and store the misalignment amount.

### TECHNICAL FIELD

The present invention relates to a vehicle light fixture system and a method for controlling a vehicle light fixture unit, and particularly relates to a vehicle light fixture system and a method for controlling a vehicle light fixture unit that are capable of calculating a misalignment amount of an optical axis of the vehicle light fixture unit, without preparing a dedicated light source unit in addition to the vehicle light fixture unit.

### BACKGROUND ART

There has been known a system that uses a dedicated light source unit for emitting light for optical axis adjustment in addition to a vehicle light fixture unit, and calculates a misalignment amount of an optical axis of the vehicle light fixture unit so as to adjust the optical axis of the vehicle light fixture unit (see, for example, Patent Literature 1).

### CITATION LIST

### Patent Literature

Patent Literature 1: Japanese Unexamined Patent Application Publication No. 2019-111883

### SUMMARY OF INVENTION

### Technical Problem

However, according to Patent Literature 1, it is possible to calculate the misalignment amount of the optical axis of the vehicle light fixture unit, but there is a need to prepare a dedicated light source unit in addition to the vehicle light fixture unit.

The present invention was made to solve such a problem, and the purpose of the present invention is to provide a vehicle light fixture system and a method for controlling a vehicle light fixture unit that can calculate the misalignment amount of the vehicle light fixture unit, without preparing a dedicated light source unit in addition to the vehicle light fixture unit.

### Solution to Problem

A vehicle light fixture system according to the present invention includes: a vehicle light fixture unit; a masking-target-object detection sensor including a camera configured to capture an image ahead of a vehicle, and a masking-target-object position detection unit configured to detect, based on the image captured by the camera, at least a position of a head lamp of an oncoming vehicle as a position of a masking target object present in front of the vehicle; a non-illumination area setting unit configured to set, based on the position of the masking target object, a non-illumination area in which the masking target object is not illuminated; a light-fixture-unit control unit configured to control the vehicle light fixture unit to illuminate an illumination area other than the non-illumination area; a reference spot pattern position storage unit configured to store in advance a position of a reference spot pattern that is formed, on a screen disposed ahead of the vehicle, by light emitted from the vehicle light fixture unit installed on the vehicle, in a state in which an optical axis is aligned with a designed optical axis; a misalignment amount calculation unit configured to calculate a misalignment amount; and a misalignment amount storage unit configured to store the misalignment amount, wherein, when an instruction to start an optical axis correction is input, the light-fixture-unit control unit controls the vehicle light fixture unit to form, on the screen, a spot pattern corresponding to a head lamp of a virtual oncoming vehicle, the camera captures an image including the spot pattern corresponding to the head lamp of the virtual oncoming vehicle on the screen, the masking-target-object position detection unit detects, based on the image including the spot pattern corresponding to the head lamp of the virtual oncoming vehicle on the screen, a position of the spot pattern corresponding to the head lamp of the virtual oncoming vehicle on the screen, and the misalignment amount calculation unit calculates, based on the position of the reference spot pattern and the position of the spot pattern corresponding to the head lamp of the virtual oncoming vehicle on the screen, a misalignment amount of the spot pattern corresponding to the head lamp of the virtual oncoming vehicle with respect to the reference spot pattern.

According to such a configuration, it is possible to calculate the misalignment amount of the optical axis of the vehicle light fixture unit, without preparing a dedicated light source unit in addition to the vehicle light fixture unit.

This is because the misalignment amount of the optical axis of the vehicle light fixture unit is calculated using the spot pattern illuminated by the vehicle light fixture unit, rather than a dedicated light source unit.

The vehicle light fixture system further includes an illumination and non-illumination areas correction unit configured to correct the illumination area and the non-illumination area, wherein, when an instruction to start an optical axis correction is not input, the camera captures an image ahead of the vehicle, the masking-target-object position detection unit detects, based on the image captured by the camera, a position of a masking target object present in front of the vehicle, the non-illumination area setting unit sets, based on the position of the masking target object, a non-illumination area in which the masking target object is not illuminated, the illumination and non-illumination areas correction unit corrects, based on the misalignment amount stored in the misalignment amount storage unit, the illumination area and the non-illumination area, and the light-fixture-unit control unit controls the vehicle light fixture unit to illuminate the corrected illumination area other than the corrected non-illumination area.

Thus, even if the optical axis of the vehicle light fixture unit is misaligned due to installation errors or the like of the vehicle light fixture unit, glare to the masking target object can be prevented.

This is because the non-illumination area is corrected, based on the misalignment amount stored in the misalignment amount storage unit.

A method for controlling a vehicle light fixture unit according to the present invention, includes: a step of controlling the vehicle light fixture unit installed on a vehicle so as to form, on a screen disposed ahead of the vehicle, a spot pattern corresponding to a head lamp of a virtual oncoming vehicle; a step of detecting a position of the spot pattern corresponding to the head lamp of the virtual oncoming vehicle on the screen; a step of calculating, based on a position of a reference spot pattern stored in advance and the position of the spot pattern corresponding to the head lamp of the virtual oncoming vehicle on the screen, a misalignment amount of the spot pattern corresponding to the head lamp of the virtual oncoming vehicle with respect to the reference spot pattern; and a step of storing the misalignment amount.

The method for controlling the vehicle light fixture unit may include: a step of detecting a masking target object present in front of the vehicle; a step of setting a non-illumination area in which the masking target object is not illuminated; a step of correcting, based on the stored misalignment amount, the non-illumination area and an illumination area other than the non-illumination area; and a step of controlling the vehicle light fixture unit to illuminate the corrected illumination area other than the corrected non-illumination area.

### Advantageous Effects of Invention

The present invention can provide the vehicle light fixture system and the method for controlling the vehicle light fixture unit that can calculate the misalignment amount of the optical axis of the vehicle light fixture unit, without preparing a dedicated light source unit in addition to the vehicle light fixture unit.

### BRIEF DESCRIPTION OF DRAWINGS

FIG. 1 is a schematic structural view of a vehicle light fixture system 10;

FIG. 2 is a view for explaining a left spot pattern LP1, a right spot pattern RP1, and so on;

FIG. 3 is a schematic view showing elements of Equation 1 to Equation 6, and Equation 7 to Equation 12;

FIG. 4A is an example of the positions of bright-dark boundary lines CL1, CL2 (angle θ_{LE1}, angle θ_{LE2}) set by a non-illumination area setting unit 33;

FIG. 4B is an example of the bright-dark boundary lines CL1, CL2 formed when the left spot pattern LP1 is misaligned with respect to a left reference spot pattern LP2 by an angle θLD (see FIG. 2);

FIG. 4C is an example of an ADB light distribution pattern P_{ADB};

FIG. 5 is a flowchart of a misalignment amount calculation process;

FIG. 6 is a flowchart of an ADB light distribution pattern formation process;

FIG. 7 is an example of mask margins M1, M2;

FIG. 8 is a schematic structural view of the vehicle light fixture system 10 (modified example);

FIG. 9 is a flowchart of the ADB light distribution pattern formation process of the modified example;

FIG. 10A is an example of the ADB light distribution pattern P_{ADB} (bright-dark boundary lines CL1, CL2) formed when the left spot pattern LP1 is misaligned with respect to the left reference spot pattern LP2 by an angle θLD (see FIG. 2); and

FIG. 10B is an example of the ADB light distribution pattern P_{ADB} (bright-dark boundary lines CL1, CL2) after correction.

### DESCRIPTION OF EMBODIMENTS

Hereinafter, a vehicle light fixture system 10 as an embodiment of the present invention will be described with reference to the drawings. Corresponding components in the drawings are labeled with the same reference signs, and repeated description will be omitted.

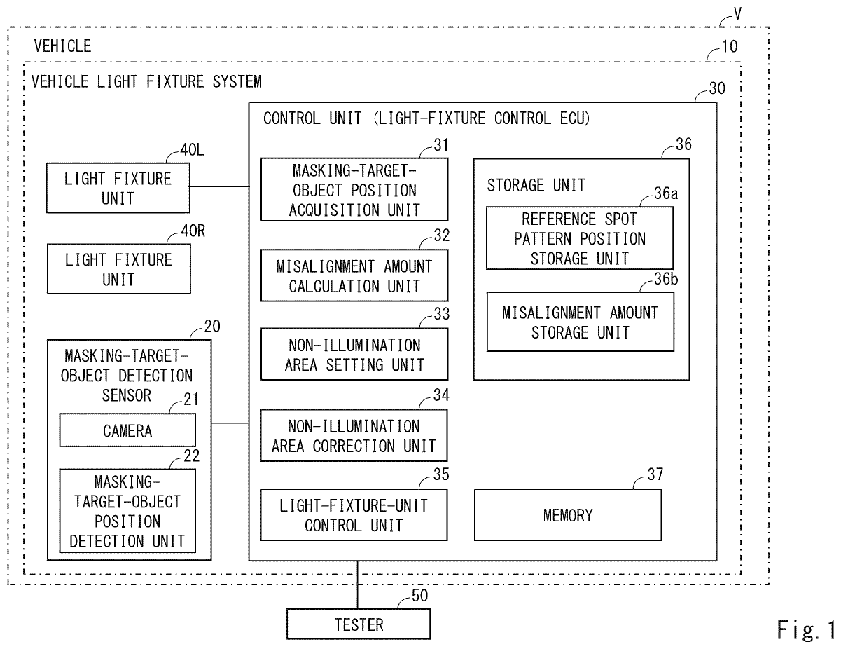

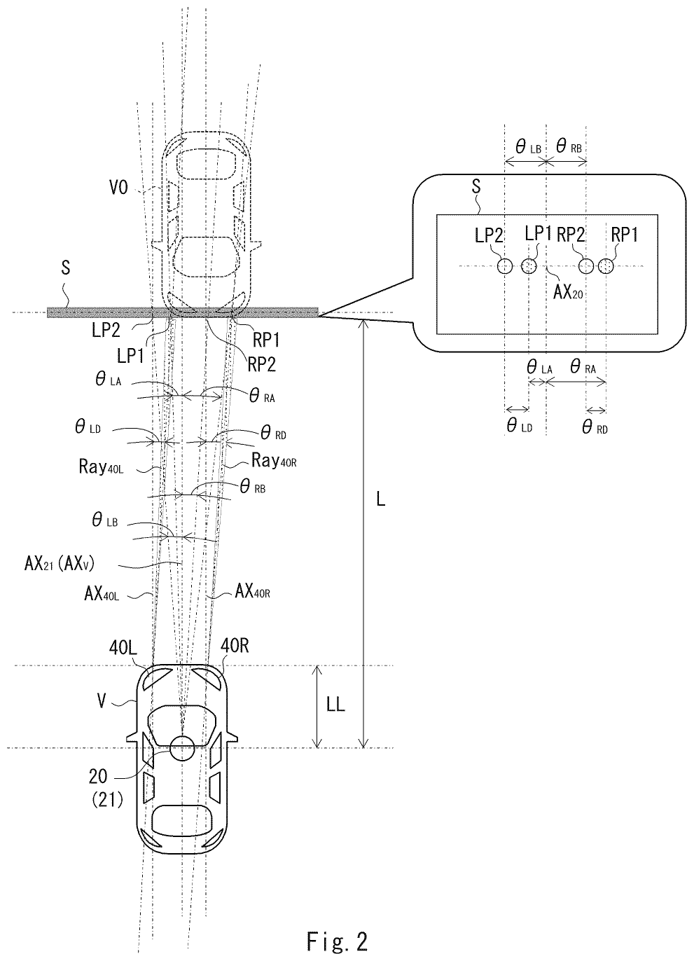

FIG. 1 is a schematic structural view of the vehicle light fixture system 10. FIG. 2 is a view for explaining a left spot pattern LP1, a right spot pattern RP1, and so on.

As shown in FIG. 1, the vehicle light fixture system 10 includes a masking-target-object detection sensor 20, a control unit 30, light fixture units 40L, 40R, and so on. A tester 50 is, for example, a malfunction inspection tester, and is used for inputting an instruction to start an optical axis correction (for example, a correction execution command) as to be described later. The vehicle light fixture system 10 is installed on a vehicle such as an automobile. Hereinafter, a vehicle on which the vehicle light fixture system 10 is installed is called an own vehicle V.

The masking-target-object detection sensor 20 is a sensor with an oncoming vehicle detection function, and includes a camera 21, and a masking-target-object position detection unit 22. The masking-target-object position detection unit 22 can be realized by software or hardware.

The masking-target-object detection sensor 20 is installed, for example, in the interior cabin of the own vehicle V, at the center in a vehicle width direction (see FIG. 2). An optical axis AX₂₁ of the camera 21 and a central axis AX_{V} of the own vehicle V are aligned with each other.

The camera 21 is an image capturing element, such as a CCD sensor and a CMOS sensor. The camera 21 captures images ahead of the own vehicle V periodically (for example, at intervals of 60 ms) through a front windshield.

The masking-target-object position detection unit 22 detects, based on the images (image data) captured by the camera 21 (by performing predetermined image processing on the images), at least the position of a head lamp of an oncoming vehicle as the position of a masking target object present in front of the own vehicle V. Examples of the masking target object are an oncoming vehicle traveling in an opposing lane in front of the own vehicle V, and a preceding vehicle traveling in front of the own vehicle V in the same lane as the own vehicle V.

The position of the masking target object is, for example, the position of a head lamp of the oncoming vehicle with respect to the own vehicle V (the optical axis AX₂₁ of the camera 21), and the position of a tail lamp of the preceding vehicle with respect to the own vehicle V (the optical axis AX₂₁ of the camera 21).

For example, as shown in FIG. 2, assuming that a left spot pattern LP1 and a right spot pattern RP1 corresponding to the head lamps of a virtual oncoming vehicle V0 are formed on a screen S disposed ahead of the own vehicle V. The left spot pattern LP1 is a light spot formed on the screen S by light Ray_{40L} emitted from a left light fixture unit 40L installed on the own vehicle V. Note that the optical axis of the left light fixture unit 40L installed on the own vehicle V is not always aligned with the designed optical axis AX_{40L} due to installation errors or the like. Similarly, the right spot pattern RP1 is a light spot formed on the screen S by light Ray_{40R} emitted from the right light fixture unit 40R installed on the own vehicle V. Note that the optical axis of the right light fixture unit 40R installed on the own vehicle V may not always be aligned with a designed optical axis AX_{40R} due to installation errors or the like.

In this case, the masking-target-object position detection unit 22 detects the positions of the left spot pattern LP1 and the right spot pattern RP1 corresponding to the head lamps of the virtual oncoming vehicle V0 as the position of the masking target object present in front of the own vehicle V. In FIG. 2, a left angle θ_{LA} and a right angle θ_{RA} represent the positions of the left spot pattern LP1 and the right spot pattern RP1 corresponding to the head lamps of the virtual oncoming vehicle V0. The left angle θ_{LA} and the right angle θ_{RA} represent misalignment amounts seen from the camera 21.

Note that, in FIG. 2, the own vehicle V faces the screen S, and is stopped in a state in which the optical axis AX₂₁ of the camera 21 (and the central axis AX_{V} of the own vehicle V) is orthogonal to the screen S. In FIG. 2, sign L represents the distance between the masking-target-object detection sensor 20 (camera 21) and the screen S, and sign LL represents the distance between the masking-target-object detection sensor 20 (camera 21) and the light fixture units 40L, 40R).

The position of the masking target objects (for example, the left angle θ_{LA} and the right angle θ_{RA}) detected by the masking-target-object position detection unit 22 as described above is transmitted to the control unit 30.

The control unit 30 is, for example, an electronic control unit (ECU) including a processor (not shown), a storage unit 36, and a memory 37. The ECU is, for example, a light-fixture control ECU.

The processor is, for example, a central processing unit (CPU). The processor may be one, or more than one. The processor functions as a masking-target-object position acquisition unit 31, a misalignment amount calculation unit 32, a non-illumination area setting unit 33, a non-illumination area correction unit 34, and a light-fixture-unit control unit 35 by executing a predetermined program (not shown) read into the memory 37 (for example, RAM) from the storage unit 36. One or all of these units may be realized by hardware.

The masking-target-object position acquisition unit 31 acquires (receives) the position of the masking target object (for example, the left angle θ_{LA} and right angle θ_{RA}) transmitted from the masking-target-object detection sensor 20 (the masking-target-object position detection unit 22).

The misalignment amount calculation unit 32 calculates, based on the positions of reference spot patterns and the positions of spot patterns corresponding to the head lamps of the virtual oncoming vehicle V0 on the screen S, a misalignment amount of the left spot pattern LP1 with respect to a left reference spot pattern LP2, and a misalignment amount of the right spot pattern RP1 with respect to a right reference spot pattern RP2.

For example, as shown in FIG. 2, assuming that the left spot pattern LP1 and the right spot pattern RP1 corresponding to the head lamps of the virtual oncoming vehicle V0 are formed on the screen S disposed ahead of the own vehicle V. In FIG. 2, the left reference spot pattern LP2 is a light spot formed on the screen S by light emitted from the left light fixture unit 40L installed on the own vehicle V, in a state in which the optical axis is aligned with a designed optical axis AX_{40L}.

Similarly, the right reference spot pattern RP2 is a light spot formed on the screen S by light emitted from the right light fixture unit 40R installed on the own vehicle V, in a state in which the optical axis is aligned with the designed optical axis AX_{40R}. In FIG. 2, a left angle θ_{LB} and a right angle θ_{RB} indicate the positions of the left reference spot pattern LP2 and the right reference spot pattern RP2, respectively. The positions (left angle θ_{LB} and right angle θ_{RB}) of the left reference spot pattern LP2 and the right reference spot pattern RP2 are stored in advance in the storage unit 36 (reference spot pattern position storage unit 36a).

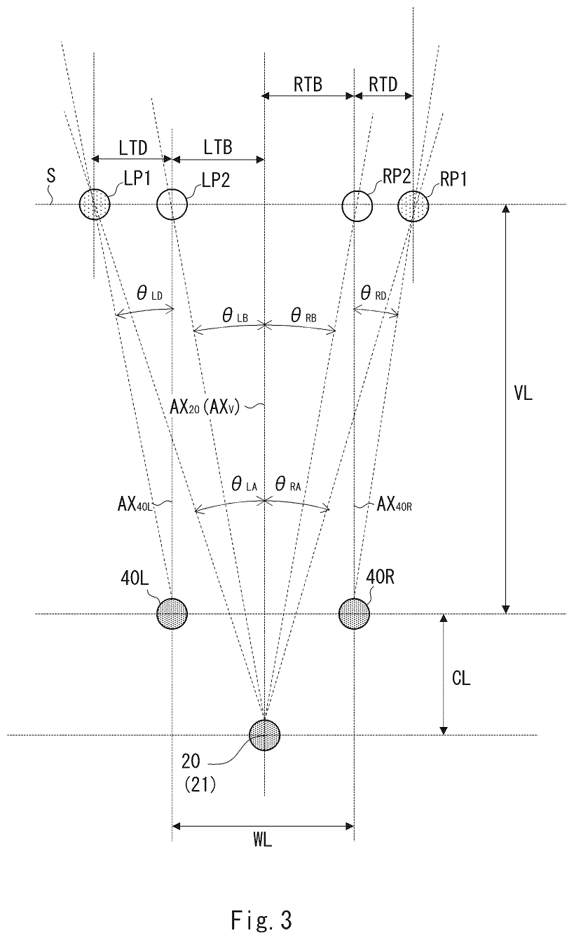

In FIG. 2, the left angle θLD is the misalignment amount of the left spot pattern LP1 with respect to the left reference spot pattern LP2. This misalignment amount (angle θLD) can be calculated by Equation 1 to Equation 6. FIG. 3 is a schematic view showing the elements of Equation 1 to Equation 6, and Equation 7 to Equation 12. In FIG. 3, sign AX_{40L} represents the designed optical axis of the left light fixture unit 40L. Similarly, sign AX_{40R} represents the designed optical axis of the right light fixture unit 40R. The designed optical axis AX_{40L} of the left light fixture unit 40L (and the designed optical axis AX_{40R} of the right light fixture unit 40R) and the optical axis AX₂₁ of the camera 21 are parallel to each other.

LTB=(VL+CL)×tan(θ_{LB}) (Equation 1)

Here, LTB is the distance from the optical axis AX₂₁ of the camera 21 to the left spot pattern LP1. VL is the distance between the light fixture units 40L, 40R and the screen S. CL is the distance between the light fixture units 40L, 40R and the masking-target-object detection sensor 20 (camera 21).

(LTD+LTB)/(VL+CL)=tan(θ_{LA}) (Equation 2)

Here, LTD is the distance between the left spot pattern LP1 and the left reference spot pattern LP2.

LTD+LTB=(VL+CL)×tan(θ_{LA}) (Equation 3)

LTD=(VL+CL)×tan(θ_{LA})−LTB (Equation 4)

LTD=(VL+CL)×(tan(θ_{LA})−tan(θ_{LB})) (Equation 5)

θ_{LD}=arctan(LTD/VL) (Equation 6)

In FIG. 2, the angle θRD is the misalignment amount of the right spot pattern RP1 with respect to the right reference spot pattern RP2. This misalignment amount (angle θRD) can be calculated by the following Equation 7 to Equation 12.

RTB=(VL+CL)×tan(θ_{RB}) (Equation 7)

Here, RTB is the distance from the optical axis AX₂₁ of the camera 21 to the right spot pattern RP1.

(RTD+RTB)/(VL+CL)=tan(θ_{RA}) (Equation 8)

Here, RTD is the distance between the right spot pattern RP1 and the right reference spot pattern RP2.

RTD+RTB=(VL+CL)×tan(θ_{RA}) (Equation 9)

RTD=(VL+CL)×tan(θ_{RA})−RTB (Equation 10)

RTD=(VL+CL)×(tan(θ_{RA})−tan(θ_{RB})) (Equation 11)

θ_{RD}=arctan(RTD/VL) (Equation 12)

The misalignment amount (angle θ_{LD}) of the left spot pattern LP1 with respect to the left reference spot pattern LP2 and the misalignment amount (angle θ_{RD}) of the right spot pattern RP1 with respect to the right reference spot pattern RP2 calculated by the misalignment amount calculation unit 32 as described above are stored as correction values in the storage unit 36 (misalignment amount storage unit 36b).

The non-illumination area setting unit 33 sets, based on the position of the masking target object detected by the masking-target-object position detection unit 22, a non-illumination area in which the masking target object is not illuminated. The non-illumination area is a darker area (dimmed area or unlit area) compared to an illumination area.

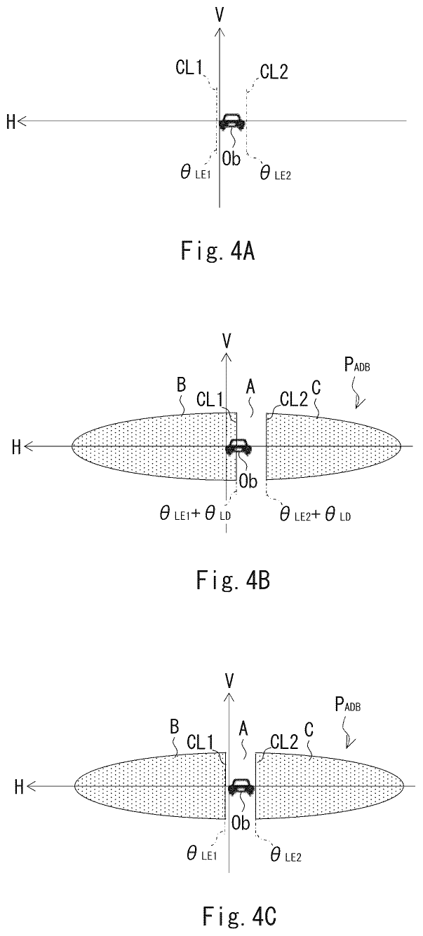

For example, supposing that a masking target object (oncoming vehicle Ob) is detected as shown in FIG. 4A. In this case, the non-illumination area setting unit 33 sets the positions (angle θ_{LE1}, angle θ_{LE2}) of two bright-dark boundary lines CL1, CL2 extending in a vertical direction (perpendicular direction) as the non-illumination area. FIG. 4A shows an example of the positions (angle θ_{LE1}, angle θ_{LE2}) of the bright-dark boundary lines CL1, CL2 set by the non-illumination area setting unit 33.

Here, when the left spot pattern LP1 is misaligned with respect to the left reference spot pattern LP2 by the angle θ_{LD} (see FIG. 2) (that is, the optical axis of the left light fixture unit 40L is misaligned from the designed optical axis AX_{40L}), the bright-dark boundary lines CL1, CL2 are formed at positions of angle θ_{LE1}+angle θ_{LD}, and angle θ_{LE2}+angle θ_{LD} as shown in FIG. 4B.

As a result, the oncoming vehicle Ob is illuminated, and glare to the oncoming vehicle Ob cannot be prevented. FIG. 4B shows an example of the bright-dark boundary lines CL1, CL2 that are formed when the left spot pattern LP1 is misaligned with respect to the left reference spot pattern LP2 by the angle θ_{LD} (see FIG. 2). The same can be said for the case in which the right spot pattern RP1 is misaligned with respect to the right reference spot pattern RP2 by the angle θ_{RD} (see FIG. 2) (that is, the optical axis of the right light fixture unit 40R is misaligned from the designed optical axis AX_{40R}).

Then, the non-illumination area set by the non-illumination area setting unit 33 is corrected by the non-illumination area correction unit 34.

The non-illumination area correction unit 34 corrects, based on the misalignment amounts (angle θ_{LD}, angle θ_{RD}) stored in the storage unit 36 (misalignment amount storage unit 36b), the non-illumination area set by the non-illumination area setting unit 33.

Specifically, regarding the light fixture unit 40L, the non-illumination area correction unit 34 subtracts the misalignment amount (angle θ_{LD}) stored in the storage unit 36 (misalignment amount storage unit 36b) from the positions (angle θ_{LE1}, angle θ_{LE2}) of the two bright-dark boundary lines CL1, CL2 set by the non-illumination area setting unit 33. The same can be said for the light fixture unit 40R.

Consequently, as shown in FIG. 4C, the bright-dark boundary lines CL1, CL2 are formed at the corrected positions, that is, the positions of the angle θ_{LE1} and angle θ_{LE2}. As a result, the oncoming vehicle Ob is not illuminated, and glare to the oncoming vehicle can be prevented.

The light-fixture-unit control unit 35 controls the light fixture units 40L, 40R to illuminate areas other than the non-illumination area. Specifically, the light-fixture-unit control unit 35 controls the vehicle light fixture units 40L, 40R to illuminate areas other than the non-illumination area after being corrected by the non-illumination area correction unit 34. For example, as shown in FIG. 4C, the light-fixture-unit control unit 35 controls the light fixture units 40L, 40R to form the ADB light distribution pattern P_{ADB} including the bright-dark boundary lines CL1, CL2 formed at the positions corrected by the non-illumination area correction unit 34, that is, the positions of the angle θ_{LE1} and angle θ_{LE2}.

FIG. 4C shows an example of the ADB light distribution pattern P_{ADB}.

As shown in FIG. 4C, the ADB light distribution pattern P_{ADB} includes a non-illumination area A in which the masking target object (for example, the oncoming vehicle Ob) is not illuminated, and illumination areas B, C to illuminate other areas, and is formed in a high beam area. Note that the bright-dark boundary lines CL1, CL2 extend in the vertical direction (perpendicular direction) at the boundaries between the non-illumination area A and the illumination areas B, C.

The light fixture units 40L, 40R may have any configuration as long as the light fixture units 40L, 40R are light fixture units of variable light distribution type which are capable of forming the ADB light distribution pattern P_{ADB} according to the control from the light-fixture-unit control unit 35.

For example, the light fixture units 40L, 40R may be direct projection type (also called direct lighting type) light fixture units (LED segment type ADB light fixture units) including a plurality of light sources disposed in a horizontal direction, direct projection type (also called direct lighting type) light fixture units (LED array type ADB light fixture units) including a plurality of light sources disposed in a matrix pattern, ADB light fixture units of micro electro mechanical system (MEMS), light fixture units of digital mirror device (DMD) type, ADB light fixture units of electronic light blocking type using a liquid crystal display (LCD), or ADB light fixture units having other configurations.

The storage unit 36 is, for example, a non-volatile readable and writable storage unit such as flash memory.

The storage unit 36 includes the reference spot pattern position storage unit 36a, and the misalignment amount storage unit 36b.

The position (left angle θ_{LB}) of the left reference spot pattern LP2, and the position (right angle θ_{RB}) of the right reference spot pattern RP2 are stored in advance in the reference spot pattern position storage unit 36a. The misalignment amounts (angle θ_{LD}, angle θ_{RD}) calculated by the misalignment amount calculation unit 32 are stored in the misalignment amount storage unit 36b.

Next, a misalignment calculation process will be described as an example of operation of the vehicle light fixture system 10 of the above configuration. The misalignment calculation process is a process for calculating the misalignment amount (angle θ_{LD}) of the left spot pattern LP1 with respect to the left reference spot pattern LP2, and the misalignment amount (angle θ_{RD}) of the right spot pattern RP1 with respect to the right reference spot pattern RP2.

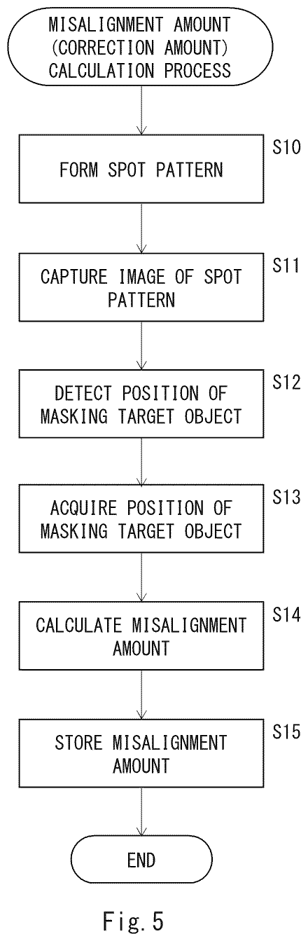

FIG. 5 is a flowchart of the misalignment amount calculation process.

Hereinafter, as a premise, as shown in FIG. 2, the own vehicle V faces the screen S, and is stopped in a state in which the optical axis AX₂₁ of the camera 21 (and the central axis AX_{V} of the own vehicle V) is orthogonal to the screen S. The following process is executed, for example, when the optical axes of the light fixture units 40L, 40R are manually adjusted in an aiming step during assembling of the vehicle, a vehicle inspection, etc. The following process is started by inputting an instruction to start an optical axis correction from the tester 50 that is electrically connected to the control unit 30.

When the instruction to start an optical axis correction (for example, a correction execution command) is input from the tester 50, first, a spot pattern is formed on the screen S (step S10). This is realized by the light-fixture-unit control unit 35 controlling the light fixture units 40L, 40R so as to form, on the screen S, the left spot pattern LP1 and the right spot pattern RP1 corresponding to the head lamps of the virtual oncoming vehicle V0. The left spot pattern LP1 and the right spot pattern RP1 are formed with similar size and brightness to the headlamps of a general vehicle, on the screen S, so as to be detected by the masking-target-object position detection unit 22.

Next, an image of the spot pattern (left spot pattern LP1 and right spot pattern RP1) formed on the screen S is captured by the camera 21 (step S11).

Next, the position of the masking target object is detected (step S12). This is realized by the masking-target-object position detection unit 22 performing predetermined image processing on the image (image data) captured in step S11.

Here, supposing that the positions (left angle θ_{LA}, right angle θ_{RA}, see FIG. 2) of the left spot pattern LP1 and the right spot pattern RP1 corresponding to the head lamps of the virtual oncoming vehicle V0 are detected as the position of the masking target object. The detected positions (left angle θ_{LA}, right angle θ_{RA}) of the left spot pattern LP1 and the right spot pattern RP1 are transmitted to the control unit 30.

Next, the masking-target-object position acquisition unit 31 acquires the position of the masking target object (step S13). Here, supposing that the positions (left angle θ_{LA}, right angle θ_{RA}) of the left spot pattern LP1 and the right spot pattern RP1 transmitted from the masking-target-object detection sensor 20 (masking-target-object position detection unit 22) are acquired (received) as the position of the masking target object.

Next, a misalignment amount is calculated (step S14). This is realized by the misalignment amount calculation unit 32 calculating, based on the positions of the reference spot patterns and the positions of the spot patterns corresponding to the head lamps of the virtual oncoming vehicle V0 on the screen S, the misalignment amount of the left spot pattern LP1 with respect to the left reference spot pattern LP2, and the misalignment amount of the right spot pattern RP1 with respect to the right reference spot pattern RP2. Here, supposing that the angle θ_{LD} and angle θ_{RD} (see FIG. 2) are calculated as the misalignment amounts. The calculated misalignment amounts (angle θ_{LD} and angle θ_{RD}) are stored in the storage unit 36 (misalignment amount storage unit 36b).

The misalignment amount (angle θ_{LD}) of the left spot pattern LP1 with respect to the left reference spot pattern LP2 and the misalignment amount (angle θ_{RD}) of the right spot pattern RP1 with respect to the right reference spot pattern RP2 are calculated as described above.

Next, an ADB light distribution pattern formation process will be described as an example of operation of the vehicle light fixture system 10 of the above configuration.

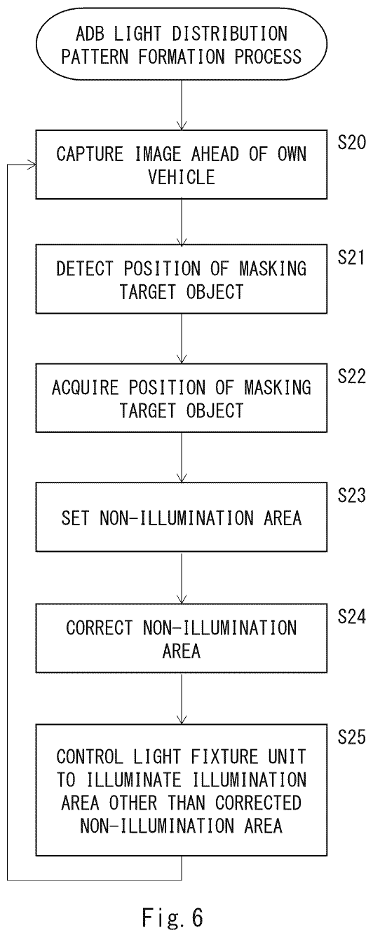

FIG. 6 is a flowchart of the ADB light distribution pattern formation process. Hereinafter, the ADB light distribution pattern formation process for the left light fixture unit 40L will be described as a representative of the process. Since the ADB light distribution pattern formation process for the right light fixture unit 40R is the same, the description will be omitted.

Hereinafter, as a premise, as shown in FIG. 2, the left spot pattern LP1 is misaligned with respect to the left reference spot pattern LP2 by the angle θ_{LD} (that is, the optical axis of the left light fixture unit 40L is misaligned from the designed optical axis AX_{40L}). Moreover, the misalignment amount (angle θ_{LD}) is stored in advance in the storage unit 36 (misalignment amount storage unit 36b). The following process is executed while the own vehicle V is traveling.

Note that, in the following process, since the tester 50 is not electrically connected to the control unit 30, an instruction to start an optical axis correction is not input.

First, an image ahead of the own vehicle V is captured by the camera 21 (step S20).

Next, the position of the masking target object is detected (step S21). This is realized by the masking-target-object position detection unit 22 detecting, based on the image (image data) captured in step S20 (by performing predetermined image processing on the image), a position s of a masking target object present in front of the own vehicle V. Here, supposing that the positions (left angle, right angle) of the head lamps of the oncoming vehicle Ob are detected as the position of the masking target object. The detected positions (left angle, right angle) of the head lamps of the oncoming vehicle Ob are transmitted to the control unit 30.

Next, the masking-target-object position acquisition unit 31 acquires the position of the masking target object (step S22). Here, supposing that the positions of the head lamps of the oncoming vehicle Ob transmitted from the masking-target-object detection sensor 20 (masking-target-object position detection unit 22) are acquired (received) as the position of the masking target object.

Next, a non-illumination area is set (step S23). This is realized by the non-illumination area setting unit 33 setting, based on the position of the masking target object acquired in step S22 (the positions of the head lamps of the oncoming vehicle Ob), a non-illumination area in which the masking target object is not illuminated. Here, as shown in FIG. 4A, the positions of two bright-dark boundary lines CL1, CL2 extending in the vertical direction (perpendicular direction) are set as the non-illumination area.

Here, when the left spot pattern LP1 is misaligned with respect to the left reference spot pattern LP2 by the angle θ_{LD} (see FIG. 2) (that is, the optical axis of the left light fixture unit 40L is misaligned from the designed optical axis AX_{40L}), as shown in FIG. 4B, the bright-dark boundary lines CL1, CL2 are formed at positions of angle θ_{LE1} angle θ_{LD}, and angle θ_{LE2}+angle θ_{LD}. As a result, the oncoming vehicle Ob is illuminated, and glare to the oncoming vehicle Ob cannot be prevented.

Therefore, the non-illumination area set in step S23 is corrected (step S24). This is realized by the non-illumination area correction unit 34 correcting, based on the misalignment amounts (angle θ_{LD}, angle θ_{RD}) stored in the storage unit 36 (misalignment amount storage unit 36b), the non-illumination area set by the non-illumination area setting unit 33. Specifically, the non-illumination area correction unit 34 subtracts the misalignment amount (angle θ_{LD}) stored in the storage unit 36 (misalignment amount storage unit 36b) from the positions (angle θ_{LE1}, angle θ_{LE2}) of the two bright-dark boundary lines CL1, CL2 set by the non-illumination area setting unit 33.

Next, the light fixture unit 40L is controlled to illuminate an area other than the non-illumination area corrected in step S24 (step S25). For example, as shown in FIG. 4C, the light-fixture-unit control unit 35 controls the light fixture unit 40L to form the ADB light distribution pattern P_{ADB} including the bright-dark boundary lines CL1, CL2 formed at the positions corrected in step S24, that is, the positions of the angle θ_{LE1} and angle θ_{LE2}. Consequently, the light fixture unit 40L forms the ADB light distribution pattern P_{ADB} including the bright-dark boundary lines CL1, CL2 formed at the positions corrected in step S24, that is, the positions of the angle θ_{LE1} and angle θ_{LE2}, according to the control from the light-fixture-unit control unit 35.

By correcting the non-illumination area (the positions of the bright-dark boundary lines CL1, CL2) as described above, the bright-dark boundary lines CL1, CL2 are formed at the positions corrected in step S24, that is, the positions of the angle θ_{LE1} and angle θ_{LE2}. As a result, the masking target object (here, the oncoming vehicle Ob) is not illuminated, and glare to the masking target object (here, the oncoming vehicle Ob) can be prevented.

As described above, according to the present embodiment, it is possible to calculate the misalignment amounts of the optical axes of the vehicle light fixture units (light fixture units 40L, 40R), without preparing a dedicated light source unit in addition to the vehicle light fixture units.

This is because the misalignment amounts (angle θ_{LD} and angle θ_{RD}) of the optical axes of the vehicle light fixture units are calculated using the spot patterns (left spot pattern LP1, right spot pattern RP1) illuminated by the vehicle light fixture units, rather than a dedicated light source unit.

Moreover, according to the present embodiment, even if the optical axes of the vehicle light fixture units (light fixture units 40L, 40R) are misaligned due to installation errors or the like of the vehicle light fixture units (light fixture units 40L, 40R), glare to the masking target object can be prevented.

This is because the non-illumination area is corrected, based on the misalignment amounts stored in the misalignment amount storage unit.

Further, according to the present embodiment, the following advantages are provided.

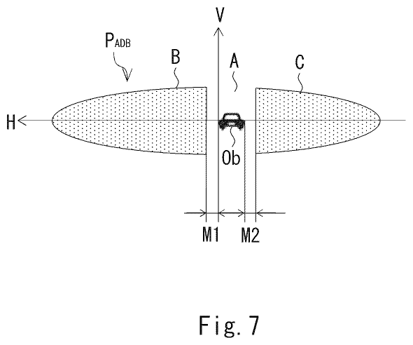

FIG. 7 is an example of mask margins M1, M2.

That is, in general, the width of a non-illumination area A (the width in the horizontal direction) is set wider by considering the mask margins M1, M2 (see FIG. 7) so that, even if the optical axes are misaligned due to installation errors or the like of the head lamps (for example, the light fixture units 40L, 40R), the masking target object is not illuminated. Therefore, even if the optical axes are misaligned due to installation errors or the like of the head lamps (for example, the light fixture units 40L, 40R), glare to the masking target object (for example, the oncoming vehicle Ob) can be prevented. However, as the width of the non-illumination area A (the width in the horizontal direction) is increased, the widths of illumination areas B, C (the widths in the horizontal direction) are decreased. As a result, forward visibility is reduced.

In contrast, according to the present embodiment, even if the optical axes are misaligned due to installation errors or the like of the head lamps (for example, the light fixture units 40L, 40R), the non-illumination area (the positions of the bright-dark boundary lines CL1, CL2) are corrected, thereby forming the bright-dark boundary lines CL1, CL2 at the positions corrected in step S24, that is, the positions of the angle θ_{LE1} and angle θ_{LE2} as shown in FIG. 4C. As a result, even if the optical axes are misaligned due to installation errors or the like of the head lamps (for example, the light fixture units 40L, 40R), the masking target object (for example, the oncoming vehicle Ob) is not illuminated, and glare to the masking target object (for example, the oncoming vehicle Ob) can be prevented. Moreover, as the width of the non-illumination area A (the width in the horizontal direction) can be made narrower, the widths of the illumination areas B, C (the widths in the horizontal direction) are increased. As a result, forward visibility is improved.

As described above, according to the present embodiment, the misalignment amounts between the installation direction of the camera 21 and the illumination directions of the light fixture units 40L, 40R are reduced to improve the accuracy of the illumination range, and the forward visibility of the own vehicle V can be improved without dazzling the surroundings.

Further, according to the present embodiment, with the use of a partial lighting-shading control (illumination control) function, which is originally possessed by an ADB light fixture system that performs illumination control on the vehicle light fixture units (light fixture units 40L, 40R) depending on a surrounding traffic environment, and an oncoming vehicle detection function, which is the basic function of the masking-target-object detection sensor 20 (illumination control sensor), it is possible to calculate the misalignment amounts, without adding a new apparatus other than the configuration for realizing the ADB light fixture system (mainly, the masking-target-object detection sensor 20, the control unit 30, and the light fixture units 40L, 40R). Furthermore, the non-illumination area can be corrected based on the misalignment amounts.

Next, a modified example will be described.

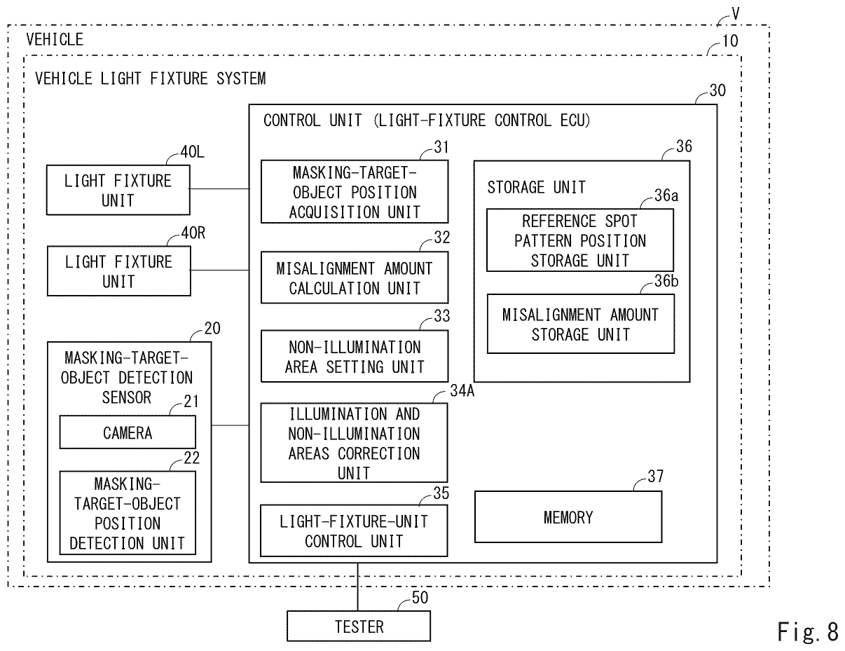

The above-described embodiment describes the example using the non-illumination area correction unit 34 that corrects, based on the misalignment amounts (angle θ_{LD}, angle θ_{RD}) stored in the storage unit 36 (misalignment amount storage unit 36b), the non-illumination area set by the non-illumination area setting unit 33, but this is not a limitation. For example, as shown in FIG. 8, an illumination and non-illumination areas correction unit 34A may be used. FIG. 8 is a schematic structural view of (a modified example of) the vehicle light fixture system 10. The illumination and non-illumination areas correction unit 34A corrects, based on the misalignment amounts (angle θ_{LD}, angle θ_{RD}) stored in the storage unit 36 (misalignment amount storage unit 36b), the illumination area and the non-illumination area.

The misalignment amount calculation process of this modified example is the same as that in the above-described embodiment (see FIG. 5).

Next, the ADB light distribution pattern formation process will be described as an example of operation of the vehicle light fixture system 10 of the modified example.

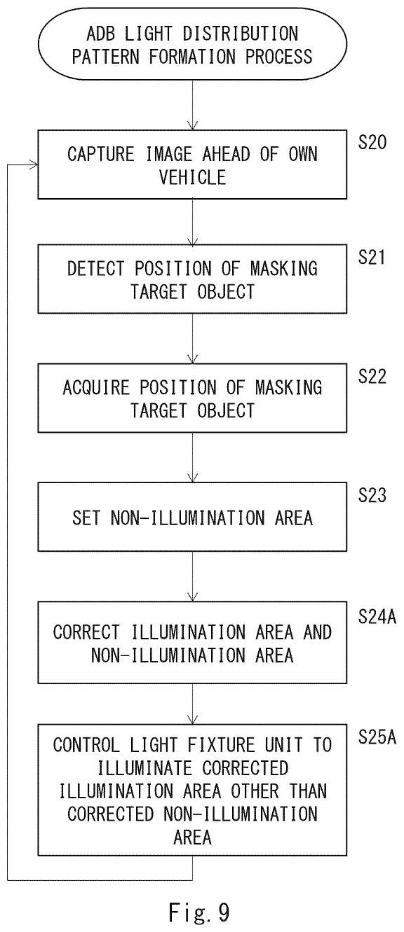

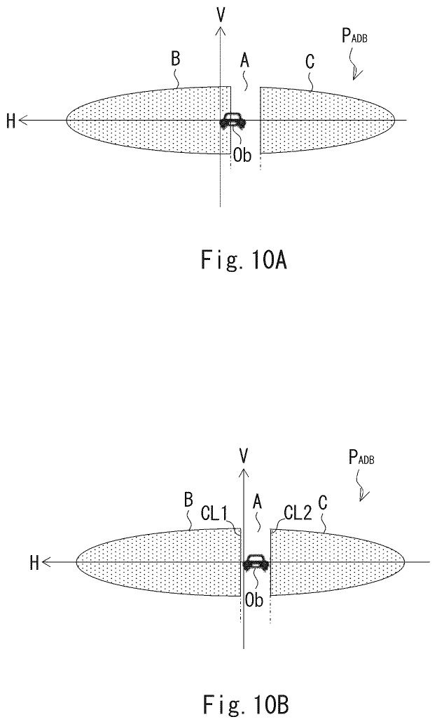

FIG. 9 is a flowchart of the ADB light distribution pattern formation process of the modified example. FIG. 10A is an example of the ADB light distribution pattern P_{ADB} (bright-dark boundary lines CL1, CL2) formed when the left spot pattern LP1 is misaligned with respect to the left reference spot pattern LP2 by the angle θ_{LD} (see FIG. 2), and FIG. 10B is an example of the ADB light distribution pattern P_{ADB} (bright-dark boundary lines CL1, CL2) after being corrected. FIG. 9 is equivalent to FIG. 6, in which steps S24 and S25 in FIG. 6 are replaced with step S24A and step S25A. Hereinafter, step S24A and step S25A as the differences will be described.

In step S24A, the illumination areas and the non-illumination area set in step S23 are corrected. This is realized by the illumination and non-illumination areas correction unit 34A correcting, based on the misalignment amounts (angle θ_{LD}, angle θ_{RD}) stored in the storage unit 36 (misalignment amount storage unit 36b), the illumination areas and the non-illumination area set by the non-illumination area setting unit 33. For example, the illumination and non-illumination areas correction unit 34A shifts the positions at which the illumination areas (see signs B, C in FIG. 10A) are formed, and a position at which the non-illumination area (see sign A in FIG. 10A) is formed to the left (or right) direction by the misalignment amount (for example, angle θ_{LD}) stored in the storage unit 36 (misalignment amount storage unit 36b).

Next, in step S25A, the light fixture unit 40L is controlled to illuminate the corrected illumination areas (see signs B, C in FIG. 10B) other than the non-illumination area (see sign A in FIG. 10B) corrected in step S24A.

Consequently, the light fixture unit 40L illuminates the corrected illumination areas (see signs B, C in FIG. 10B) other than the non-illumination area (see sign A in FIG. 10B) corrected in step S24A, according to the control from the light-fixture-unit control unit 35. That is, the ADB light distribution pattern P_{ADB} including the illumination areas (see signs B, C in FIG. 10B) and the non-illumination area (see sign A in FIG. 10B) is formed at a position shifted to the left (or right) by the misalignment amount (for example, the angle θ_{LD}) stored in the storage unit 36 (misalignment amount storage unit 36b).

By correcting the illumination areas and the non-illumination area set in step S23 as described above, the non-illumination area A (the bright-dark boundary lines CL1, CL2) is formed at the position corrected in step S24A. As a result, the masking target object (here, the oncoming vehicle Ob) is not illuminated, and glare to the masking target object (here, the oncoming vehicle Ob) can be prevented.

With this modified example, it is also possible to exhibit the same effects as those of the above-described embodiment.

All the numerical values stated in the respective embodiments are examples, and it is, of course, possible to use any suitable numerical values different from these values.

The above-described embodiments are just examples in all respects. The present invention should not be construed as being limited by the descriptions of the embodiments. The present invention can be embodied in various other forms without departing from the spirit or essential characteristics of the present invention.

This application claims priority based on Japanese Patent Application No. 2021-073435 filed on Apr. 23, 2021, the disclosure of which is incorporated herein in its entirety.

### REFERENCE SIGNS LIST

10 VEHICLE LIGHT FIXTURE SYSTEM
20 MASKING-TARGET-OBJECT DETECTION SENSOR
21 CAMERA
22 MASKING-TARGET-OBJECT POSITION DETECTION UNIT
30 CONTROL UNIT
31 MASKING-TARGET-OBJECT POSITION ACQUISITION UNIT
32 MISALIGNMENT AMOUNT CALCULATION UNIT
33 NON-ILLUMINATION AREA SETTING UNIT
34 NON-ILLUMINATION AREA CORRECTION UNIT
35 LIGHT-FIXTURE-UNIT CONTROL UNIT
36 STORAGE UNIT
36a REFERENCE SPOT PATTERN POSITION STORAGE UNIT
36b MISALIGNMENT AMOUNT STORAGE UNIT
37 MEMORY
40L LEFT LIGHT FIXTURE UNIT
40R RIGHT LIGHT FIXTURE UNIT
50 TESTER
A NON-ILLUMINATION AREA
B, C ILLUMINATION AREA
CL1, CL2 BRIGHT-DARK BOUNDARY LINE
LP1 LEFT SPOT PATTERN
LP2 LEFT REFERENCE SPOT PATTERN
M1, M2 MASK MARGIN
Ob ONCOMING VEHICLE
P_{ADB} ADB LIGHT DISTRIBUTION PATTERN
RP1 RIGHT SPOT PATTERN
RP2 RIGHT REFERENCE SPOT PATTERN
S SCREEN
V OWN VEHICLE
V0 VIRTUAL ONCOMING VEHICLE

1. A vehicle light fixture system comprising:
a vehicle light fixture unit;
a masking-target-object detection sensor including a camera configured to capture an image ahead of a vehicle, and a masking-target-object position detection unit configured to detect, based on the image captured by the camera, at least a position of a head lamp of an oncoming vehicle as a position of a masking target object present in front of the vehicle;
a non-illumination area setting unit configured to set, based on the position of the masking target object, a non-illumination area in which the masking target object is not illuminated;
a light-fixture-unit control unit configured to control the vehicle light fixture unit to illuminate an illumination area other than the non-illumination area;
a reference spot pattern position storage unit configured to store in advance a position of a reference spot pattern that is formed, on a screen disposed ahead of the vehicle, by light emitted from the vehicle light fixture unit installed on the vehicle, in a state in which an optical axis is aligned with a designed optical axis;
a misalignment amount calculation unit configured to calculate a misalignment amount; and
a misalignment amount storage unit configured to store the misalignment amount, wherein,
when an instruction to start an optical axis correction is input,
the light-fixture-unit control unit controls the vehicle light fixture unit to form, on the screen, a spot pattern corresponding to a head lamp of a virtual oncoming vehicle,
the camera captures an image including the spot pattern corresponding to the head lamp of the virtual oncoming vehicle on the screen,
the masking-target-object position detection unit detects, based on the image including the spot pattern corresponding to the head lamp of the virtual oncoming vehicle on the screen, a position of the spot pattern corresponding to the head lamp of the virtual oncoming vehicle on the screen, and
the misalignment amount calculation unit calculates, based on the position of the reference spot pattern and the position of the spot pattern corresponding to the head lamp of the virtual oncoming vehicle on the screen, a misalignment amount of the spot pattern corresponding to the head lamp of the virtual oncoming vehicle with respect to the reference spot pattern.

2. The vehicle light fixture system according to claim 1, further comprising an illumination and non-illumination areas correction unit configured to correct the illumination area and the non-illumination area, wherein,
when an instruction to start an optical axis correction is not input,
the camera captures an image ahead of the vehicle,
the masking-target-object position detection unit detects, based on the image captured by the camera, a position of a masking target object present in front of the vehicle,
the non-illumination area setting unit sets, based on the position of the masking target object, a non-illumination area in which the masking target object is not illuminated,
the illumination and non-illumination areas correction unit corrects, based on the misalignment amount stored in the misalignment amount storage unit, the illumination area and the non-illumination area, and
the light-fixture-unit control unit controls the vehicle light fixture unit to illuminate the corrected illumination area other than the corrected non-illumination area.

3. A method for controlling a vehicle light fixture unit, comprising:
a step of controlling the vehicle light fixture unit installed on a vehicle so as to form, on a screen disposed ahead of the vehicle, a spot pattern corresponding to a head lamp of a virtual oncoming vehicle;
a step of detecting a position of the spot pattern corresponding to the head lamp of the virtual oncoming vehicle on the screen;
a step of calculating, based on a position of a reference spot pattern stored in advance and the position of the spot pattern corresponding to the head lamp of the virtual oncoming vehicle on the screen, a misalignment amount of the spot pattern corresponding to the head lamp of the virtual oncoming vehicle with respect to the reference spot pattern; and
a step of storing the misalignment amount.

4. The method for controlling the vehicle light fixture unit according to claim 3, including:
a step of detecting a masking target object present in front of the vehicle;
a step of setting a non-illumination area in which the masking target object is not illuminated;
a step of correcting, based on the stored misalignment amount, the non-illumination area and an illumination area other than the non-illumination area; and
a step of controlling the vehicle light fixture unit to illuminate the corrected illumination area other than the corrected non-illumination area.
